(19) United States
(12) Patent Application Publication
(10) Pub. No.: US 2001/0017776 A1
(43) Pub. Date: Aug. 30, 2001

(54) Light-emitting adder

(75) Inventors: Vladimir Vadimovich Solodovnokov, Moskovskaya obl. (RU); Anatoly Fedorovich Lavrov, Moskva (RU)

Correspondence Address: BAKER & BOTTS, 30 ROCKEFELLER PLAZA, NEW YORK, NY, 10112

(73) Assignee: REYTEQ LASER INDUSTRIES, LTD.

(21) Appl. No.: 09/783,475

(22) Filed: Feb. 14, 2001

Related U.S. Application Data
(63) Continuation-in-part of application No. PCT/RU98/00363, filed on Nov. 4, 1998.

(51) Int. Cl. F21V 9/14; F21K 2/00

(52) U.S. Cl. 362/259; 362/84; 362/235; 362/268; 362/551; 362/800; 362/19

(57) ABSTRACT

A light-emitting adder allowing to obtain a high brightness, integrated, substantially coherent light beam illuminating a target area either evenly or with increased brightness in the center of the illuminated spot, comprises a plurality of light sources located in a same plane and beam-shaping means provided with beam-transporting means in order to form the resultant beam. Various ranges of variations for optical lengths L and wavelengths λ of the light sources, as well as for degrees of beams mixing, are proposed.

### FIELD OF THE INVENTION

The present invention relates to high brightness, high power output density light sources and is particularly concerned with light sources using laser diodes.

### DESCRIPTION OF THE PRIOR ART

One of the problems of great importance in laser engineering consists in providing coherent light source having high brightness and high power output density wherein such light could be coupled e.g. into an optical fiber of 50 μm diameter.

Known are various structures of high brightness light-emitting adders (see WO 92/02844 and U.S. Pat. No. 5,319,528, including those comprising laser diodes. In these systems, individual sources have a stripe-geometry emission region in the cross-sectional plane perpendicular to the optical axis of the respective source. In order to fit the light energy e.g. into an optical fiber, it is necessary to obtain a substantially circular spot on the target area thus reducing the energy loss. The conventional structures, as well as that described in the paper by T. Y. Fan and Antonio Sanchez, IEEE Journal of Quantum Electronics (1990), Vol. 26, No. 2, pp. 311-316, use anamorphic, collimating and shaping means ensuring a quasi total illumination of the target area while having isolated regions of each source's beams propagation within the acceptance angle from the focusing means to the focusing zone where said target area is located.

Another light-emitting adder disclosed in U.S. Pat. No. 5,463,534 comprises at least two light sources with identical stripe geometry of the emission regions. The light-emitting stripes of the output ends have their mutually perpendicular sides with a long dimension and a short dimension in the cross-sections perpendicular to the optical axes of the light sources. Said right sources are spaced apart from the focusing zone at distances equal to the optical lengths L as calculated from each individual source to the focusing zone taking into account the refractive indices of the medium along the beam path (see Handbook of General Physics, Vol, 3, G. S. Landsberg, Optics”, State Publishing House for Engineering and Theoretical Literature, Moscow, 1952. p. 84). In the above-mentioned known system. the optical lengths L, μm, differ from source to source.

Provided between the light sources and the focusing zone are imaging means comprising beam shaping means allowing to collimate the beam in mutually perpendicular directions parallel to the sides of the light-emitting stripe, and focusing means to focus the collimated beams onto the focusing zone accommodating the target area.

In such a light-emitting adder, the required illumination of the target area is obtained with the aid of cylindrical telescopes, as well as collimating and focusing means included in said imaging means, said focusing means having substantially equal focal lengths in x-axis and y-axis. The inventors emphasized the fact that within the acceptance angle between the focusing means and the target area, the beams emitted by each light source occupy well defined different spaces without propagating through the adjacent regions. Consequently, the resultant beam will include, as regards its spectral parameters and wavelengths, the entire spread characteristic of the individual light sources. Problems then arise, especially in the case of laser diodes, in achieving a maximum output brightness with a minimum number of original light sources used, such problems being particularly critical when need is felt to deliver the light energy into an optical fiber.

### SUMMARY OF THE INVENTION

The invention aims to provide a light-emitting adder with, on the one hand increased brightness and power output density and, on the other hard, reduced energy loss along the optical path and while illuminating the target area and/or at least partly reflecting means, there being additionally provided the possibility of self-adjustment of said adder, its increased efficiency at different wavelengths, simplified beam positioning and manufacturing process, as well as the ease of implementation.

The adder of the invention comprises a plurality of laser sources, each of which emits a beam having a rectangular cross-section in a plane perpendicular to the source optical axis, viz. its direction of propagation. Said cross-section has a long side and a short side. The long side will be called herein the longitudinal one and its direction will be called the x-direction. The short side will be called the transverse one and its direction will be called the y-direction. The transverse, numerical aperture NAy of the beams is much greater than the longitudinal, numerical aperture NAx: e.g. NAy=0.5 and NAy=0.1. The adder is structured so as to provide a final concentrated beam impinging on a target area. The length of the path traveled by each beam from its sources to the target will be called “the optical length” of the source and indicated by L; and the differences between the optical lengths of any two sources will be indicated by ΔL.

The adder comprises:

1—the said plurality of laser sources;

2—means for collimating the emitted laser beams in the y-direction, said means being located close to the sources, viz. close to the origin of the beams, to reduce their lateral divergence;

3—beam adding means, for juxtaposing the laser beams collimated in the y-direction;

4—means for collimating the added beams in the x-direction for obtaining a substantially square, final, concentrated beam; and

5—means for focusing said concentrated beam at or near the target.

Preferably, the ratio of the differences L of the optical paths of any two laser sources is not greater than the lengths of said optical paths, viz. ΔL/L≦0.1.

According to a first embodiment of the invention, these objects are attained in a light-emitting adder comprising at least two light sources with stripe-geometry emission regions in the sections perpendicular to the optical axes of said light sources, the mutually perpendicular sides of the light-emitting stripes at the output ends of said light sources having a long dimension and a short dimension. a target area and imaging means interposed between said light sources and a focusing zone, and including beam-shaping means provided with means for collimating beams in mutually perpendicular directions parallel to the sides of said light-emitting stripes, as well as focusing means for focusing onto said focusing zone, the output end of each light source being spaced apart from said focusing zone at distances equal to the optical lengths L, wherein said light sources are selected in order to allow the longitudinal emission at one at least wavelength X, and are located in a plane perpendicular to the long or the short dimension of said light emitting stripes, viz. perpendicular or parallel to the long dimensions, the values of optical lengths are selected within the range L−ΔL×L+ΔL, where the deviation ΔL of the optical lengths is taken so as not to exceed 10% of said optical lengths L. Said beam-shaping means are provided, at the light sources' end and for each of them, with means for collimating beams in the direction parallel to the short dimension of each stripe. There is further provided at least one beam-transporting means capable, on at least a part of its extent, of partly overlapping the beams, and downstream of said beam-transporting means within said beam-shaping means there are positioned means for collimating beams in the direction parallel to the long dimension of the stripe. It should be understood that the “overlapping” of beams, which could also be called “mixing”, is always partial, and this should always be understood as implicit, even if not stated, every time that the term “overlapping” is used hereinafter.

In certain cases, such a light-emitting adder may comprise light sources made in the form of either stripe-shaped laser diodes or stripe-shaped superluminescent diodes.

In a preferred embodiment of the invention, the laser diodes of the light-emitting adder of the invention are located, symmetrically with respect to an axis passing through the center of the target, in a plane perpendicular to the long or the short dimension of the light-emitting stripes, said axis being called herein the optical axis of the adder. The provision of beam-shaping means, having spaced-apart means ensuring the collimation along different axes parallel to the respective sides of said stripes with beam-transporting means placed therebetween, as well as in the selection of substantially equal optical lengths L differing from one another by predetermined deviations ±ΔL depending on the kind of the light source, result, when taken in combination, in new performances and output characteristics of the light-emitting adder such as increased brightness and power output density with, at the same time, a lower number of light sources, simplified manufacturing process and beam positioning, and lesser energy loss.

Also, preferably, the optical lengths of different light sources are such that they differ from one another not more than by a value ΔL in the range of 2 to 8% of said optical lengths L, viz. ΔL/L=0.02+0.08.

The combination of the structural features of the adder of the invention results in increased brightness and power output density with, at the same time, a lower number of light sources, a simplified manufacturing process and beam positioning, and lesser energy loss.

In an embodiment of the invention, reflecting means are provided in the target area for reflecting a beam or each of a number of beams, originating from one light source, to another light source.

In another embodiment of the invention, the laser diodes are located symmetrically with respect to the optical axis of the adder, one of the diodes, which will be called the pilot source, being located on said axis and the other diodes being in phase with said pilot source and satisfying what will be called “the coherence condition”, according to which the deviations ΔL of the optical lengths of the sources and the deviations δλ of the wavelengths of the light emitted by said sources, satisfy for at least one pair of laser diodes located symmetrically on opposite sides of the adder's optical axis, the coherence condition ΔL≦πλ²/8δλ (see Kolomiytsev “Interferometers”, “Mashinostroyeniye” publishers, Leningrad Division, 1979. p. 85), leading to a further increase in the brightness and the power output density of the light provided by the adder. For the laser diodes, if any, that do not satisfy said condition, the deviations ΔL of the optical lengths is taken so as not to exceed 10% of said optical lengths L.

It has been found that the aforesaid features of the adder provided with beam-transporting means capable of partially overlapping beams from different light sources, allow to obtain a regular illumination of the target area positioned within the focusing zone. In such a system, the brightness in the center of the spot is substantially the same as at its periphery and in the case of e.g. optical fiber, the total required emissive power will be delivered across its whole diameter.

According to a second embodiment of the invention, the above-stated objects are attained in a light-emitting adder comprising at least two light sources with stripe geometry emission regions in the sections perpendicular to the optical axes of said light sources, the mutually perpendicular sides of the light-emitting stripes at the output ends of said light sources having a long dimension and a short dimension, a target area and imaging means interposed between said light sources and a focusing zone and including beam-shaping means provided with means for collimating beams in mutually perpendicular directions parallel to the sides of said light-emitting stripes, as well as focusing means for focusing onto said focusing zone, the output end of each light source being spaced apart from said focusing zone at distances equal to the optical lengths L, wherein said light sources made in the form of laser diodes are selected in order to allow the emission at one at least wavelength λ, and are located in a plane perpendicular to the long or to the short dimension of said light-emitting stripes, said beam-shaping means being provided, at the laser diodes' end and for each of them, with means for collimating beams in the direction parallel to the short dimension of each stripe, There is also provided at least one beam-transporting means capable, on at least a part of its extent, of overlapping the beams. There is also positioned, downstream of said beam-transporting means within said beam-shaping means, collimating means for collimating beams in the direction parallel to the long dimension of the stripes. Preferably, there is further provided, in said focusing zone, at least partly reflecting means, the values of optical lengths L being selected within the range L−ΔL÷L+L ΔL. where ΔL is the deviation of said optical lengths L, and the combination of deviations ΔL of the optical lengths and deviations δλ, of the wavelengths, for at least one pair of laser diodes located symmetrically about the adder's optical axis, being taken so as to satisfy the coherence condition, i.e. ΔL≦ πλ²/8δλ, whereas for the remaining laser diodes, the deviation ΔL of the optical lengths is taken so as not to exceed 10% of said optical lengths L.

This second embodiment of the light-emitting adder, possessing the same essential features as the first one, with the difference consisting in the laser diodes selected as light sources and in the deviations ΔL of the optical lengths and Δλ of the wavelengths which are taken, for at least two laser diodes, so as to satisfy the coherence condition, differs from said first embodiment by the provision of at least partly reflecting means allowing to improve the characteristics of the symmetric emitters due to their reciprocal influence, thus enabling, combined with the proposed beam-shaping means, the self-adjustment of the entire light-emitting adder and, hence, of the totality of laser diodes. This results in the following new performances and output characteristics of the light-emitting adders.

The suggested ranges of differences of wavelengths and optical lengths of the laser diodes chosen in order to satisfy the coherence condition, as well as the adopted arrangement of the structural components used, allow to obtain an integrated, substantially coherent light beam of required diameter and brightness. In the plane perpendicular to the long or short dimension of the light-emitting stripes, the individual collimated coherent beams emitted by each source are brought into a well packed integrated light beam characterized by a predetermined, at least partial mixing of the adjacent beams on at least a part of the path within said beam-transporting means. After having passed through said beam-transporting means, the resulting integrated beam is collimated in the perpendicular plane and has substantially equal optical lengths over the entire cross-section. Such an integrated beam produced in the proposed unique structure can be considered, to a very low degree of approximation, as a single beam. Moreover, the provision of at least partly reflecting means leads as well to an increased coherence of the integrated light beam over its entire cross-section. Therefore thanks to the above unobvious and novel essential features of the light-emitting adders, it becomes possible to considerably enhance the brightness and the concentration of the beam in the center of the focusing zone with a very low divergence on the periphery of the resulting spot.

According to a still further embodiment of the invention, the light-emitting adder comprises two laser diode systems, the optical axes of which are at an angle, preferably a right angle, to one another. Each of said systems comprises one laser sources or a plurality of laser sources emitting rectangular beams having a long longitudinal side (x-side) and a short transverse side (y-side) and comprises means for collimating in the y-direction close to the sources, adding means for juxtaposing the laser beams collimated in the y-direction, and means for collimating in the x-direction to obtain a square beam, all as hereinbefore described.

Preferably each system comprises a pilot source located on the optical axis of the system, the other sources being arranged in pairs symmetrically on the two sides of the optical axis. However, in this embodiment, means are provided for adding or merging the juxtaposed and collimated laser beams of the two systems and for polarizing them, to form a single final or added beam, which is polarized; and means are further provided for focusing said polarized beam onto the target area. In each of said systems at least one pair of laser diodes located symmetrically on opposite sides of the system's optical axis satisfy the aforesaid coherence condition, while for the laser diodes, if any, that do not satisfy said condition, the deviations ΔL of the optical lengths is taken so as not to exceed 10% of said optical lengths L.

In said embodiment, all the light sources are laser diodes, selected in order to allow the emission at one at least wavelength λ, and arranged so as to have at least two sources in each of two mutually perpendicular planes, each of these planes being perpendicular to the long dimension of the respective light-emitting stripes. Imaging means are provided, which comprise, in addition to said first beam-shaping means, second beam-shaping means, both said beam-shaping means being coupled to at least two light sources and provided at said sources' end and for each of them, with means for collimating beams in the direction parallel to the short dimension of the light-emitting stripe, said first beam-shaping means further includes at least one beam-transporting means capable on at least a part of its extent, of overlapping the beams, said second beam-shaping means also incorporate at least one beam-transporting means capable, on at least a part of its extent, of overlapping the beams. There is positioned, downstream of said beam-transporting means within each of said beam-shaping means, one collimating means for collimating beams in the direction parallel to the long dimension of the light-emitting stripes, the respective optical axes of said beam-shaping means being mutually perpendicular and there being additionally provided, at their intersection downstream of said beam shaping means, a polarizer allowing, during the operation of the apparatus, to transmit the collimated beam from one of said beam-shaping means to cause the total internal reflection of the collimated beam from other of said beam-shaping means and to obtain a resulting beam on whose axis, downstream of said polarizer said focusing means are mounted, whereas in said focusing zone there is placed at least partly reflecting means, the values of optical lengths L being selected within the range L−ΔL÷L+ΔL, where ΔL is deviation of said optical lengths L and the combination of deviations ΔL of the optical lengths and deviations δλ of the wavelengths, for at least one pair of laser diodes located symmetrically about the adder's optical axis, being taken so as to satisfy the coherence condition i.e. ΔL≦ πλ²/8δλ, whereas for the remaining laser diodes, the deviation ΔL of the optical lengths is taken so as not to exceed 10% of said optical lengths L.

The above third embodiment of the light-emitting adder, possessing the same essential features as the second one. is distinguished therefrom by the structural novelty implying the use of a polarizer for its designated purpose However, this becomes only possible due to the following essential features of the system: suitable choice of laser diodes; their provision in each of the planes and appropriate relative positioning of these planes: proper design of the beam shaping means enabling to obtain substantially equal optical reflecting means that may be placed therein in certain embodiments of the invention.

In addition, all the embodiments of the invention provide that said beam-transporting means may be made with a predetermined variation of the degree of overlapping, at least in the plane perpendicular to the long dimension of the light-emitting stripes and in at least one direction, one the solutions, valid for all the three embodiments, providing that said beam-transporting means may be formed with a predetermined variation of the refractive index. As a result, it becomes possible to reduce the energy loss along the optical path and when illuminating the target area and/or said at least partly reflecting means, as well as to simplify the beam positioning operation.

Besides, the provision of said beam-transporting means allows to render less stringent the requirements placed upon the adjustment of individual emitters, thus simplifying the manufacturing process. The resulting adder assumes a compact appearance with reduced overall dimensions while improving at the same time its_principal characteristics, such as the brightness and the power output density

In all the three embodiments the number N of sources is preferably taken as an integer within the acceptable range of variations between 0.5N and 1.5N, subject to the condition:

N=[a.sin(↓ₐ/2)]/[b.sin(θ_{b}/2)]

where a and b are the dimensions of the stripe-shaped emission regions of lengths L, taking into account the deviations ΔL and δλ satisfying the coherence condition; producing two well-packed substantially coherent integrated light beams in the beam-shaping means provided with beam-transporting means as well as due to the provision of at least party reflecting means positioned within the focusing zone. Should even one of the claimed features of the invention is not fulfilled, the degree of polarization of each resultant beam leaving 3 corresponding beam-shaping means 3 will be considerably reduced thus making the use of the polarizer quite ineffective.

To achieve the above-stated objects, all the three embodiments of the invention provide also that said beam-transporting means are preferably designed with a degree of overlapping ranging from 10% to 40%, thereby increasing the brightness and the power output density.

Furthermore, in all the three embodiments, beam-transporting means are provided on the trajectory of each light beam, thus leading, here again to increased brightness and power output density due to the possibility of the self-adjustment of the adder, as well as to an increase in the input coefficient and to the simplification of the beam positioning operation and of the manufacturing process.

With the adopted degree of overlapping in the beam-transporting means equal to 10-40%, the beams leaving the sources overlap to a large extent within the acceptance angle downstream of the focusing means and overlap fully in proximity of the focusing zone. The focusing zone is wholly illuminated by each beam of the source, thereby allowing to obtain a substantially uniform illumination of this zone and of the at least partly the source for the long side and the short side. respectively, and θₐ and θ_{b} are the divergence angles in the direction of the long dimension and the short dimension, respectively. The integer closest to the number yielded by the above equation is taken as the number N.

In such a system, energy losses are lowered along the optical path and when illuminating the target area and/or said at least partly reflecting means, the number of sources used is also reduced.

In all the three embodiments, the light sources are arranged in such a manner that the centers of their emitting stripes are located in the plane perpendicular to the long or short dimension of said stripes. In addition, the target area may be placed within the focusing zone. All the above provisions result in achieving a maximum brightness.

When at least partly reflecting means are used in the target area, the planes of said target area and said reflecting means are made coincident with one another, thus simplifying the manufacturing process and making easier the implementation of the light-emitting adder.

In all the three embodiments, the laser diodes are made with wavelengthsλ, and optical lengths L such that for any pair of laser diodes located symmetrically about the optical axis of the adder, the combination of deviations ΔL of the optical lengths and deviations δλof the wavelengths satisfies the coherence condition, i.e. ΔL≦πλ²/8δλ. The above condition allows, when combined with the provision of said at least partly reflecting means, the proposed design of the beam-shaping means producing a well-packed light beam and the adopted arrangement of the laser diodes, to obtain an integrated, substantially coherent light beam leaving said beam-shaping means and to achieve the influence of the symmetric laser diodes on one another, as well as on the self-adjustment of the adder taken as a whole, thereby increasing the brightness, the power output density and the concentration of the beam energy in the center of the focusing zone.

Preferably, at least one of the laser diodes—the one that has been called the pilot source—is made with the lowest divergence angles θₐ, θ_{b} and spectral half-width. As stated hereinbefore, said laser diode is positioned on the optical axis of the adder, while other diodes are arranged symmetrically with respect to said axis. Such a solution makes it possible not only to enhance the brightness and the power output density and to ensure the self-adjustment of the adder, but also to simplify the manufacturing process.

Within the framework of the solutions under consideration, said laser diode having the lowest divergence angles θₐ, θ_{b} and spectral halt-width is advantageously of single-mode type, thus leading, owing to the possibility of self-adjustment of the adder, to an increase in the brightness and the power output density.

It is expedient to made the laser diodes with at least two values of wavelengths. In such a system a version is possible where at least one beam-shaping means are associated with an odd number, three at least, of laser diodes, the diodes with identical wavelengths being positioned symmetrically relative to the adder's optical axis.

With the proposed structure, it is possible to use laser diode sources operating at different wavelengths in order to obtain a resultant beam which would contain different wavelengths without any loss of the achieved brightness, thereby enhancing the efficiency of the adder when working at different wavelengths while maintaining at the same time its compactness and light weight. Such high brightness emitters producing substantially coherent or fully coherent light beams at different wavelengths concentrated along a same optical axis may be applied to TV appliances, diagnostic systems etc.

The present invention includes the provision of a light-emitting adder design having beam-transporting means with a predetermined degree of overlapping achieved even before shaping a collimated light beam in both directions, with a specific arrangement of components in the beam-shaping means and with substantially equal values, though differing within narrow specified ranges of the optical lengths and wavelengths of the light sources located in a same plane which is strictly oriented with respect to the emitting surface of each source and to the whole optical system. In addition, the following effects are achieved: a considerable decrease in the dissipation of the beam energy when transferring the beam from each individual emitter to the focusing zone; substantially complete mixing of beams within the acceptance angle, at least within its major part adjoining to the focusing zone, thus allowing to obtain a uniform illumination of the target area in cases where it is placed both within the focusing zone and. provided the use of appropriated optics, farther along the optical axis, a drastic increase in the brightness and the power output density. including the case of using sources with different wavelengths. Moreover, when using an adder provided with laser diodes and at least partly reflecting means, wherein coherence conditions are imposed for the variation of the optical lengths L and wavelengths λ, it becomes possible to shape substantially coherent or fully coherent beams of high brightness, as well as single-mode beams. As to the provision of a polarizer, such a solution became possible due to the fact that the required polarization of the system can be only ensured with the claimed laser diodes structure and the proper selection of their_parameters which are closely related to the adopted design of the beam-shaping means and the provision of at least partly reflecting means. Therefore all these essential distinctive features, taken in combination, allow to achieve the principal advantages of the claimed adder.

It must be understood that the proposed light-emitting adder may be technologically implemented by skilled persons using means known in the art and employed in manufacturing lasers and various optical systems.

### BRIEF DESCRIPTION OF THE DRAWINGS

In the drawings:

FIGS. 1A and 1B are a schematic representation of a light emitting adder according to an embodiment of the invention, FIG. 1A being a lateral view and FIG. 1B a plan view;

FIG. 2 is a schematic plan view of another embodiment, wherein the target represented by an optical fiber; and

FIG. 3 is a schematic plan view of a further embodiment, comprising a polarizer.

### DETAILED DESCRIPTION OF THE PREFERRED EMBODIMENTS

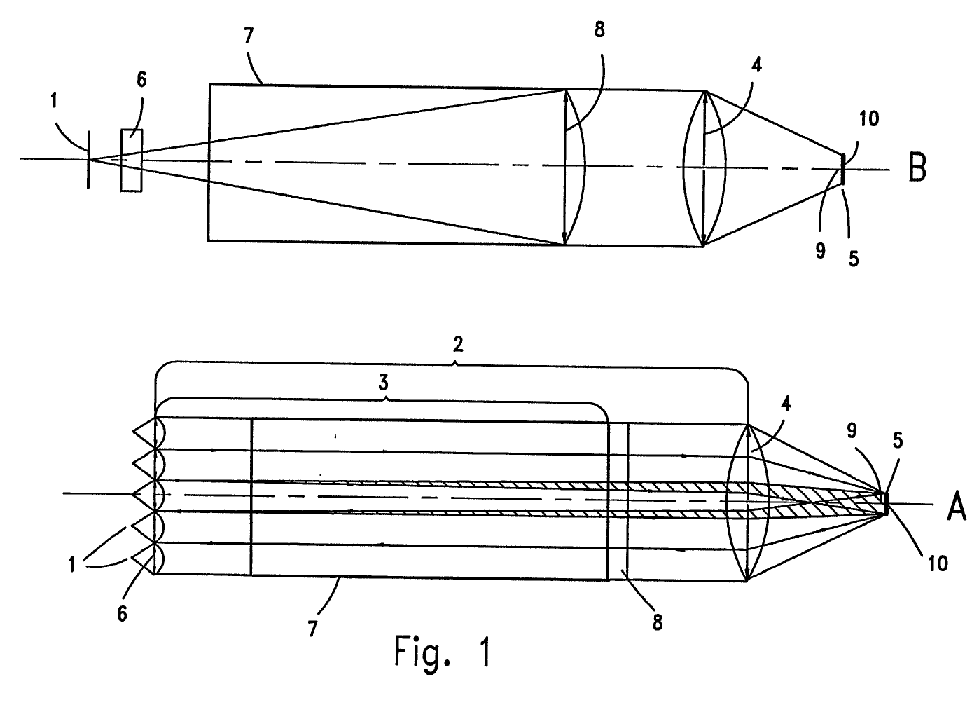

Referring now to FIG. 1, the proposed light-emitting adder (briefly called hereinafter “adder”) according to a first embodiment comprises light sources 1 (briefly called hereinafter “sources”), imaging means 2 composed of shaping means 3 and focusing means 4, and a focusing zone 5. The direction of the long dimension of the emitted light stripes is considered to be parallel to the x-axis and the direction of the short dimension is considered to be parallel to the y-axis. It is assumed that the sizes of the long side “a” and the short side “b” of the emitted stripe are identical for all the sources 1. All the light sources are located in a same plane, which is perpendicular to the long or short dimension of the stripes and extends preferably through the center thereof. The shaping means 3 comprise means 6 for collimating along the y-axis , beam-transporting means 7 and means 8 for collimating along the x-axis. The focusing zone 5 accommodates at least partly reflecting means 9 and, in the example illustrated, a target area 10. The collimating means 6 are placed immediately after the light sources 1. The light sources 1 are spaced apart from the focusing zone 5 at substantially equal distances corresponding to the optical lengths L. The optical lengths L are selected, for each source, such that they differ from one another by not more than a value ΔL amounting to 2%-8%, but not more than 10%, of the optical lengths L. The target area 10 may be positioned either within the focusing zone 5 or farther on the optical axis. In both cases (in the latter case, provided the use of suitable optics), the target area 10 will be completely occupied by all the beams issuing from the sources 1.

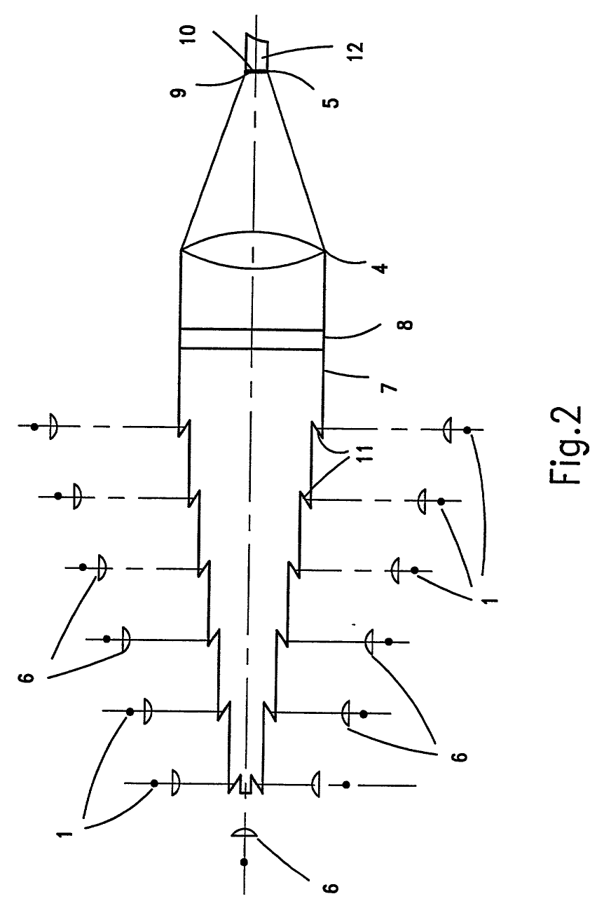

In accordance with the second embodiment (FIG. 2), the claimed light-emitting adder is designed as follows. Used as light sources are laser diodes 1 arranged in a same plane which is perpendicular to the long or short dimension of the emitted light stripes and extends preferably through the center thereof. In this particular case, there are 13 laser diodes 1. The light-emitting elements of the laser diodes I are fabricated from a heterojunction structure GaAs-lnGaAs having lasing wavelength λ=670±2 nm with a spread between different diodes lying within the limits±3 nm. In the cross-section perpendicular to the optical axis of each diode 1, the size of the emitted light stripe is of (100×1) μm². The long side of the stripes is considered to be parallel to the x-axis and the short side to the y-axis. They are located in the plane y-z, which extends through the centers of the respective stripes. The laser 1 located on the optical axis of the adder is the pilot source. In this particular example, the combination of the deviations ΔL of the optical lengths and the deviations δλ of the wavelengths, for one pair of laser diodes 1, namely for the second pair after the pilot source, located symmetrically about the adder's optical axis, satisfies the coherence condition, i.e. ΔL≦πλ²/8δλ As to other diodes, their optical lengths L are characterized by a spread of 4±1% of the corresponding optical length L.

As stated above, imaging means 2 (see FIG. 1B) are composed of shaping means 3 and focusing means 4. Shaping means 3 include, as viewed from the laser diodes 1, a system of cylindrical lenses 6 ensuring the collimation along the y-axis, which are positioned on each optical axis of the laser diodes I and having focal lengths of 0.26±0.02 cm, beam-transporting means 7 provided with input folding prisms 11 made of glass, and a cylindrical lens 8 collimating the beam along the x-axis with a focal length of 4.6±0.2 cm. Then follow the focusing means formed by a focusing lens 4 having identical (±1 μm) focal lengths along the x-axis and y-axis equal to 2.5±0.03 cm. Mounted farther on the optical axis is an optical fiber 12 whose end is positioned within the focusing zone 5 and covered with a partly reflecting coating 9 having a reflection factor P in the order of 7±0.5%.

In operation, the supply of the working current to the laser diodes 1 gives rise to the emission of a coherent light with a predetermined wavelength, or wavelengths, and a corresponding spectral half-width. Passing along the optical paths indicated in FIG. 1 by arrows directed from the sources 1 to the focusing zone 5, the light produced by each of the sources 1 reaches the target area 10 placed within said zone 5. In this travel, a part of the light is reflected from the above-mentioned at least partly reflecting means 9, made in the form of the coating 9 covering the target area 10, and then comes back to the imaging means 2 following, however, another optical path, all as indicated in FIG. 1. In said figure the solid line shows the light leaving the source 1, which is second as viewed from above in the figure, then reflected from the at least partly reflecting means 9 and finally coming back to the source 1 which is second as viewed from below in the figure. The broken line designates the path of the light emitted by the central source 1 and the hatched regions illustrate examples of beams overlapping

In the beam-transporting means 7, there is operated a partial mixing of beams (by a value of about 25±5%). The light collimated in two mutually perpendicular planes reaches the focusing means formed by the focusing lens 4 having identical (±1 μm) ,focal lengths along the x-axis and y-axis equal to 2.5±0.03 cm After having passed through said focusing lens 4, the beams will be substantially fully mixed within the acceptance angle of the target area 10 both along the x-axis and the y-axis, thus entirely illuminating, with each original part of the light, the total target area 10. i.e. a square spot of 40×40 μm², the divergence in mutually perpendicular directions being equal to 14±0.2 mrad. Said target area 10 is constituted by the end of the optical fiber 12 having a diameter of 50 μm with a numerical aperture NA of the receiving fiber equal to 0.21±0.01. The at least partly reflecting means 9 are made in the form of a coating deposited on the end of said optical fiber 12.

Each laser diode has a power output Pi averaging in the order of 250±0.10 mW. We achieved a resulting power output Pout amounting to 1.5 W over an area of 40×40 μm². So, it is evident that using few light sources, a considerably greater power output density and a higher brightness are achieved.

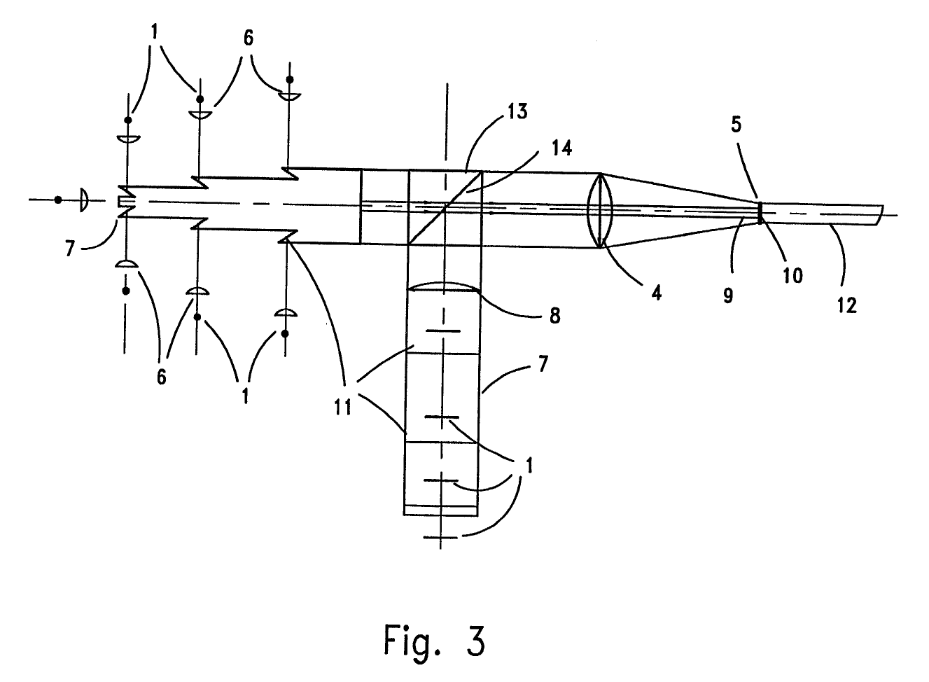

In accordance with the embodiment illustrated in FIG. 3, the claimed light-emitting adder is composed of two systems of laser diodes 1 performing the function of light sources and two shaping means associated with each of said systems of laser diodes 1. The laser diodes 1 are located in two mutually perpendicular planes, each of which is perpendicular to the long or short dimension of the respective emitted light stripes and extends preferably through their center. Each shaping means is composed of a plurality of means 6 for collimating in the direction parallel to the short dimension (the y-dimension) of the light stripes. Each shaping means further comprise at east one beam-transporting means 7 capable, on at least a part of its extent, of partly overlapping the beams, followed by means 8 for collimating in the direction parallel to the long dimension (the x-dimension) of the stripe. The respective optical axes of the shaping means of both laser system, which constitute those of the beam-transporting means 7 and of the means 8 collimating in the direction parallel to the long dimension of the stripe, are mutually perpendicular and intersect with one another downstream of the shaping means 3 and upstream of the focusing means 4 and are positioned in the planes corresponding to the location of the laser diodes 1. The planes of location of the laser diodes 1 intersect downstream of the shaping means 3. The intersection point of optical axes of the shaping means of the two laser systems is on the line of crossing of said planes of location of the laser diodes 1. The additional polarizer 13 is placed with its plane of polarization 14 at the intersection of said optical axes of the shaping means. Mounted downstream of the polarizer 12 are focusing means 4, while the focusing zone 5 incorporates the at least partly reflecting means 9. The output end of each laser diode 1 is spaced apart from the focusing zone 5 at substantially equal distance corresponding to the optical lengths L. In this system, the combination of deviations ΔL of the optical lengths and deviations ok of the wavelengths is taken, for at least one pair of laser diodes 1 located symmetrically with respect to the adder's optical axis, so that it satisfies the coherence condition, i.e. ΔL≦πλ²/8δλ, whereas for the remaining laser diodes the deviation ΔL of the optical lengths is taken so as not to exceed 10% of said optical lengths L.

Therefore, the inventors achieved a considerably higher power output density and an increased brightness of the integrated, well-packed and substantially coherent narrow light beam generated by few light sources which may operate at different wavelengths. Furthermore, the beam positioning in such sources, as well as the process of manufacture of the entire system, including its component parts, are made easier.

Light-emitting adders are widely usable in pumping solid-state lasers. in producing laser-based industrial equipment, measuring appliances, medical instrumentation, marking devices, communication facilities, as well as systems for long-distance power and data transmission.

1. A light-emitting adder comprising at least two light sources with stripe-geometry emission regions in the sections perpendicular to the optical axes of said light sources, the mutually perpendicular sides of the light-emitting stripes at the output ends of said light sources having a long dimension and a short dimension, a target area and imaging means interposed between said light sources and a focusing zone and including beam-shaping means provided with means for collimating beams in mutually perpendicular directions parallel to the sides of said light-emitting stripes, as well as focusing means for focusing onto said focusing zone, the output end of each light source being spaced apart from said focusing zone at distances equal to the optical lengths L, characterized in that said light sources are selected in order to allow the emission at one at least wavelength λ and are located in a plane perpendicular to the long or the short dimension of said light-emitting stripes, the values of optical lengths are selected within the range L−ΔL÷L+ΔL, where the deviation ΔL of the optical lengths is taken so as not to exceed 10% of said optical lengths L, said beam-shaping means forming part of said imaging means are provided, at the light sources' end and for each of them, with means for collimating beams in the direction parallel to the short dimension of each stripe, said adder further comprising at least one beam-transporting means capable, on at least a part of its extent, of partly overlapping the beams, there being further positioned within said beam-shaping means, downstream of said beam-transporting means, means for collimating beams in the direction parallel to the long dimension of the stripe.

2. A light-emitting adder as claimed in claim 1, characterized in that said light sources are made in the form of stripe-shaped laser diodes.

3. A light-emitting adder as claimed in claim 1, characterized in that said light sources are made in the form of stripe-shaped superluminescent diodes.

4. A light-emitting adder as claimed in claim 1, 2 or 3, characterized in that the value of deviation ΔL of the optical lengths is taken equal to 2%÷ 8% of said optical lengths L.

5. A light-emitting adder as claimed in claim 1 or 2. characterized in that the combination of deviations ΔL of the optical lengths and deviations δλ of the wavelengths is taken, for at least one pair of laser diodes located symmetrically about the adder's optical axis, so as to satisfy the coherence condition ΔL≦πλ²/8δλ.

6. A light-emitting adder comprising at least two light sources with stripe-geometry emission regions in the sections perpendicular to the optical axes of said light sources, the mutually perpendicular sides of the light-emitting stripes at the output ends of said light sources having a long dimension and a short dimension. a target area and imaging means interposed between said light sources and a focusing zone and including beam-shaping means provided with means for collimating beams in mutually perpendicular directions parallel to the sides of said light-emitting stripes, as well as focusing means for focusing onto said focusing zone, the output end of each light source being spaced apart from said focusing zone at distances equal to the optical lengths L, characterized in that said light sources are in the form of laser diodes selected in order to allow the emission at one at least wavelength λ, and are located in a plane perpendicular to the long or the short dimension of said light-emitting stripes, said beam-shaping means being provided, at the laser diodes' end and for each of them, with means for collimating beams in the direction parallel to the short dimension of each stripe, said adder further comprising at least one beam-transporting means capable, on at least a part of its extent, of partly overlapping the beams, and there being positioned, downstream of said beam-transporting means within said beam-shaping means, collimating means for collimating beams in the direction parallel to the long dimension of the stripes, and there being further provided, in said focusing zone, at least partly reflecting means, the values of optical lengths L being selected within the range L−ΔL÷ L+ΔL. where ΔL is deviation of said optical lengths L and the combination of deviations ΔL, of the optical lengths and deviations δλ of the wavelengths, for at least one pair of laser diodes located symmetrically about the adder's optical axis, being taken so as to satisfy the coherence condition ΔL≦πλ²/8δλ whereas for the remaining laser diodes, the deviation ΔL of the optical lengths is taken so as not to exceed 10% of said optical lengths L.

7. A light-emitting adder comprising at least two light sources with stripe-geometry emission regions in the sections perpendicular to the optical axes of said light sources, the mutually perpendicular sides of the light-emitting stripes at the output ends of said light sources having a long dimension and a short dimension, a target area and imaging means interposed between said light sources and a focusing zone and including beam-shaping means provided with means for collimating beams in mutually perpendicular directions parallel to the sides of said light-emitting stripes, as well as focusing means for focusing onto said focusing zone, the output end of each light source being spaced apart from said focusing zone at distances equal to the optical lengths L, characterized in that at least two additional light sources are provided, all the light sources are laser diodes, selected in order to allow the emission at one at least wavelength λ and arranged so as to have at least two sources in each of two mutually perpendicular planes, each of these planes being perpendicular to the long or the short dimension of the respective light-emitting stripes, said imaging means further comprising, in addition to said first beam-shaping means, second beam-shaping means, both said beam-shaping means being coupled to at least two light sources and provided, at said sources' end and for each of them, with means for collimating beams in the direction parallel to the short dimension of the light-emitting stripe, said first beam-shaping means further including at least one beam-transporting means capable on at least a part of its extent, of partly overlapping the beams, said second beam-shaping means also incorporating at least one beam-transporting means capable, on at least in part of its extent, of partly overlapping the beams, said adder further including, downstream of said beam-transporting means and within each of said beam-shaping means, one collimating means for collimating beams in the direction parallel to the long dimension of the light-emitting stripes, the respective optical axes of said beam-shaping means being mutually perpendicular and there being additionally provided, at their intersection downstream of said beam-shaping means, a polarizer allowing, during the operation of the apparatus, to transmit the collimated beam from one of said beam-shaping means. to cause the total internal reflection of the collimated beam from other of said beam-shaping means, and to obtain a resulting beam on whose axis said focusing means are mounted downstream of said polarizer, whereas in said focusing zone there is placed at least partly reflecting means, the values of optical lengths L being selected within the range L−ΔL÷L+ΔL, where ΔL is deviation of said optical lengths L and the combination of deviations ΔL of the optical lengths and deviations δλ of the wavelengths, for at least one pair of laser diodes located symmetrically about the adder's optical axis, being taken so as to satisfy the coherence condition ΔL≦πλ²/8δλ, whereas for the remaining laser diodes, the deviation ΔL of the optical lengths is taken so as not to exceed 10% of said optical lengths L.

8. A light-emitting adder as claimed in any one of claims 1 to 7, characterized in that said beam-transporting means are designed with a degree of overlapping ranging from 10% to 40%.

9. A light-emitting adder as claimed in any one of claims 1 to 8, characterized in that beam-transporting means are provided on the trajectory of the beam leaving each light source.

10. A light-emitting adder as claimed in claim 1 to 7, characterized in that said beam-transporting means are made with a predetermined variation of the degree of overlapping, at least in the plane perpendicular to the long or the short dimension of the light-emitting stripes and in at least one direction.

11. A light-emitting adder as claimed in claim 10, characterized in that said beam-transporting means are formed with a predetermined variation of the refractive index.

12. A light-emitting adder as claimed in claim 1, characterized in that the number N of sources is taken as an integer within the acceptable range of variations between 0.5N and 1.5N, subject to the condition:
N=[a.sin(θₐ/2)]/[b.sin(θ_{b}/2)]
where a and b are dimensions of the stripe-shaped emission regions of the source for the long side and the short side, respectively, and θₐ and θ_{b} are divergence angles in the direction of the long dimension and the short dimension respectively.

13. A light-emitting adder as claimed in claim 1, characterized in that the light sources are arranged in such a manner that the centers of their emitting stripes are located in the plane perpendicular to the long dimension of said stripes.

14. A light-emitting adder as claimed in claim 1, characterized in that the light sources are arranged in such a manner that the centers of their emitting stripes are located in the plane perpendicular to the short dimension of said stripes.

15. A light-emitting adder as claimed in claim 1, characterized in that the target area is placed within the focusing zone.

16. A light-emitting adder as claimed in claim 6, characterized in that the planes of said target area and said at least partly reflecting means are made coincident with one another.

17. A light-emitting adder as claimed in claim 2, characterized in that the laser diodes are made with wavelengths λ and optical lengths L such that for any pair of laser diodes located symmetrically about the optical axis of the adder, the combination of deviations ΔL of the optical lengths and deviations of the wavelengths satisfies the coherence condition ΔL≦ πλ²/8δλ.

18. A light-emitting adder as claimed in claim 17, characterized in that at least one of the laser diodes is made with the lowest divergence angles θₐ and θ_{b} and spectral half-width.

19. A light-emitting adder as claimed in claim 18, characterized in that said laser diode is positioned on the optical axis of the adder, while other diodes are arranged symmetrically with respect to the same.

20. A light-emitting adder as claimed in claim 18, characterized in that said laser diode having the lowest divergence angles θₐ and θ_{b} and spectral half-width is of single-mode type.

21. A light-emitting adder as claimed in claim 2, characterized in that the laser diodes are made with at least two values of wavelengths.

22. A light-emitting adder as claimed in claim 21, characterized in that at least one beam-shaping means are associated with an odd number, three at least, of laser diodes, the diodes with identical wavelengths being positioned symmetrically relative to the adder's optical axis.
